(19) United States
(12) Patent Application Publication
(10) Pub. No.: US 2018/0059271 A1
(43) Pub. Date: Mar. 1, 2018

(54) TRANSVERSE VIBRATION ATTENUATION MECHANISM AND METHOD FOR MARINE SEISMIC ACQUISITION SYSTEM

(71) Applicant: CGG SERVICES SAS, Massy Cedex (FR)

(72) Inventors: Frederic SIMONNOT, Oslo (NO); Jason GRANHOLT, Lierstranda (NO)

(21) Appl. No.: 15/560,293

(22) PCT Filed: May 10, 2016
(86) PCT No.: PCT/IB2016/000737

§ 371 Date: Sep. 21, 2017

Related U.S. Application Data
(60) Provisional application No. 62/160,005, filed on May 12, 2015.

(51) Int. Cl. G01V 1/20; G01V 1/38; B63B 21/66

(52) U.S. Cl. CPC G01V 1/202; G01V 1/3843; B63B 2211/02; G01V 2001/204; B63B 21/66

(57) ABSTRACT

A front-end gear connects a streamer to a vessel. The front-end gear includes a lead-in that connects to the streamer, a first bend limiting element attached to the lead-in and to a float that floats at a sea surface, a second bend limiting element attached to the lead-in, a distance L away from the first bend limiting element, and a depressor attached to the second bend limiting element. The float generates a first force (F1) on the lead-in and the depressor generates a second force (F2) on the lead-in when the lead-in is towed underwater. The first and second forces act to apply a tension in a portion of the lead-in spanning the distance L, to reduce transversal noise propagation toward the streamer.

### RELATED APPLICATION

The present application is related to, and claims priority from U.S. Provisional Patent Application No. 62/160,005, filed May 12, 2015, the disclosure of which is incorporated herein by reference.

### BACKGROUND

### Technical Field

Embodiments of the subject matter disclosed herein generally relate to methods and systems and, more particularly, to mechanisms and techniques for reducing a transversal movement (noise) transmitted from a lead-in to a streamer when the lead-in experiences vortex induced oscillations.

### Discussion of the Background

Reflection seismology is a method of geophysical exploration to determine the properties (usually by generating an image) of a geophysical formation located in a subsurface of the earth, which information is especially helpful in the oil and gas industry (e.g., drilling a well, reservoir management, etc.). Marine reflection seismology is based on the use of a controlled source that sends energy waves into the earth. By measuring the time it takes for the reflections to come back to plural receivers, it is possible to estimate the depth and/or composition of the features causing such reflections. These features may be associated with subterranean hydrocarbon deposits.

During a seismic gathering process, as shown in FIG. 1 (bird view image of the system), a vessel 100 tows an array of streamers 104. The streamers may be disposed horizontally or with a variable depth relative to the ocean's surface. Each streamer includes plural seismic sensors that record seismic waves. The seismic sensors may be hydrophones, geophones, accelerometers, optical sensors or a combination of them. Vessel 100 also tows a seismic source array 106 that is configured to generate an acoustic wave. Source array 106 may include one or more sub-arrays (the figure shows two sub-arrays for simplicity), each sub-array including one or more individual source elements (i.e., air gun, vibratory element, etc.). The acoustic wave generated by the source array propagates downwards toward the seafloor and penetrates the seafloor until eventually a reflecting structure (reflector) reflects the acoustic wave. The reflected acoustic wave propagates upwardly until the same is detected by the seismic sensors discussed above.

To maintain the plural streamers shown in FIG. 1 substantially parallel and at equal distances from each other, a front-end gear 108 is used. A front-end gear includes a collection of cables, links, ropes, etc. that connect the seismic spread (streamers and associated equipment) to the vessel.

A conventional configuration of a seismic spread and front-end gear 108 is also shown in FIG. 1. FIG. 1 shows the front-end gear 108 including wide ropes 110 provided at respective ends with deflectors 112. The wide ropes and deflectors generate a cross-line tension (note that a direction 101 along the vessel's advancing path is called inline and a substantially perpendicular direction 103 is called cross-line) that is used to separate the heads 104A of the streamers from each other. Spread ropes 116 are connected between the streamers' heads from preventing their heads to move away from each other. Plural lead-in cables 114 are connecting the streamers 104 to vessel 100. Umbilicals 107 connect the source array 106 to vessel 100. Front-end gear 108 may also include a vibration isolation module (VIM) 120, connected between a lead-in and a corresponding streamer head, for limiting axial noise that is transmitted from the front-end gear to the streamers. Note that the term “lead-in” and “umbilicals” are dedicated terms in the art and one skilled in the art would understand them as described herein, i.e., a lead-in is different from a spread rope.

FIG. 2 shows a side view of the marine acquisition system of FIG. 1. A float 130 floats at the water surface 132 and it is connected with a rope 134 to lead-in 114 or to the streamer's head. A bend limiting element 136 is attached to the lead-in and connected to rope 134. Float 130 is configured to maintain the streamer's head at a desired depth relative to the water surface 132. Bend limiting element 136 is usually a component that is mounted over the lead-in, to prevent early failure of the lead-in due to the constant up and down move exerted by the float on that portion of the lead-in. Similarly, another bend limiting element 138 is placed where spread rope 116 connects to the lead-in.

Although VIM 120 reduces axial noise that propagates from the front-end gear to the streamers, these devices are not designed to also reduce transversal or radial noise. While the VIMs can dampen axial vibration with up to −20 dB (power spectrum ratio), radial (transverse) dampening is very limited.

Transversal vibrations are especially visible for low frequencies in seismic motion sensors (e.g., accelerometers) located on the streamers and used to record multicomponent seismic data. Thus, a reduction in transversal noise would significantly improve the quality of such seismic data. Therefore, there is a need to provide a mechanism that can reduce the transversal noise that propagates from the front-end gear to the streamers.

### SUMMARY

According to an embodiment, there is a front-end gear that connects a streamer to a vessel. The front-end gear includes a lead-in that connects to the streamer, a first bend limiting element attached to the lead-in and to a float that floats at a sea surface, a second bend limiting element attached to the lead-in, a distance L away from the first bend limiting element, and a depressor attached to the second bend limiting element. The float generates a first force (F1) on the lead-in and the depressor generates a second force (F2) on the lead-in when the lead-in is towed underwater. The first and second forces act to apply a tension in a portion of the lead-in spanning the distance L, to reduce transversal noise propagation toward the streamer.

According to another embodiment, there is a front-end gear that connects a streamer to a vessel. The front-end gear includes a lead-in having a stiffer portion, which is stiffer than a rest of the lead-in, and a stiff material located in the stiff portion for making the stiffer portion stiffer than the rest of the lead-in.

According to still another embodiment, there is a method for reducing transversal movement in a lead-in. The method includes a step of connecting the lead-in to a vessel, a step of connecting the lead-in to a streamer, a step of deploying the streamer and the lead-in from the vessel, a step of making a portion of the lead-in stiffer than a rest of the lead-in, and a step of collecting seismic data with seismic sensors located along the streamer. The portion of the lead-in that is stiffer than the rest reduces a transversal noise that propagates from the lead-in to the streamer.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a marine data acquisition system;

FIG. 2 is a side view of a front-end gear;

FIGS. 3A-3C illustrate the formation of transversal noise in a lead-in for a marine seismic data acquisition system;

FIG. 4 illustrates one mechanism for attenuating a transversal noise that propagates from a lead-in to a streamer;

FIG. 5 illustrates another mechanism for attenuating a transversal noise that propagates from a lead-in to a streamer;

FIG. 6 illustrates still another mechanism for attenuating a transversal noise that propagates from a lead-in to a streamer;

FIG. 7 illustrates a bend limiting element; and

FIG. 8 is a flow chart of a method for collecting seismic data with a marine seismic data acquisition system that has a mechanism for reducing transversal noise from the lead-ins.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a method and a module for attenuating transversal noise that propagates from a front-end gear to a streamer when this system is towed underwater.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The seismic sensors distributed along the streamers record seismic energy that carries information about the underground. The signals generated by the seismic waves are small. Thus, any noise that is generated by the vessel and/or the front-end gear may greatly affect the accuracy of the seismic signals. Field measurements has shown that the transversal vibrations (that generate the transversal noise) occurring at the lead-in are comparable in size with the seismic signals. Therefore, it is important to attenuate, if not suppress, the transversal noise coming from the lead-in.

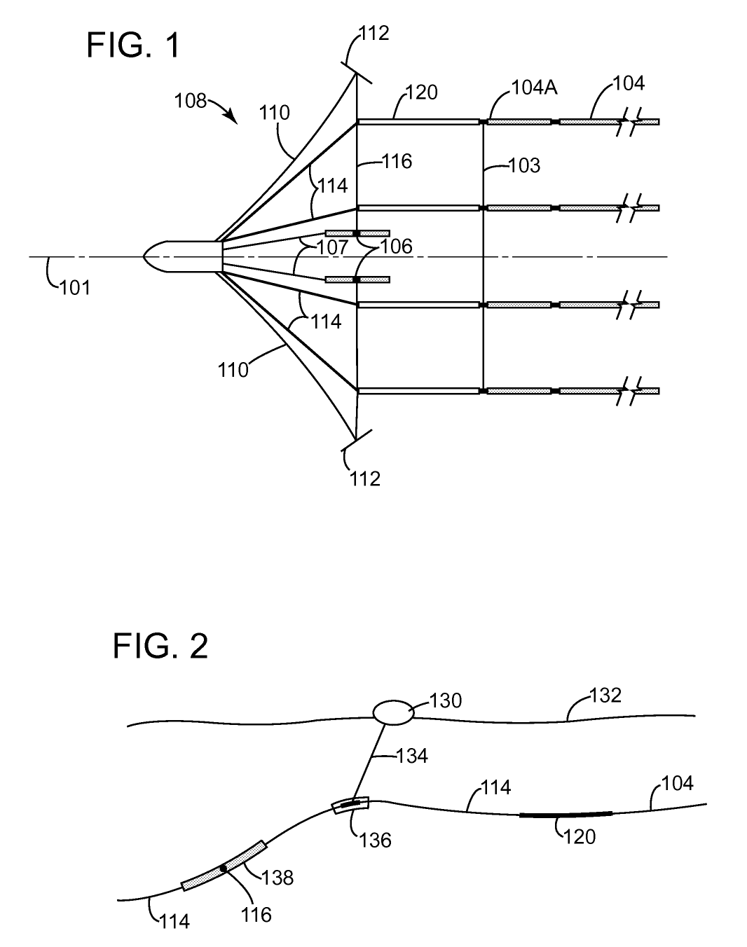

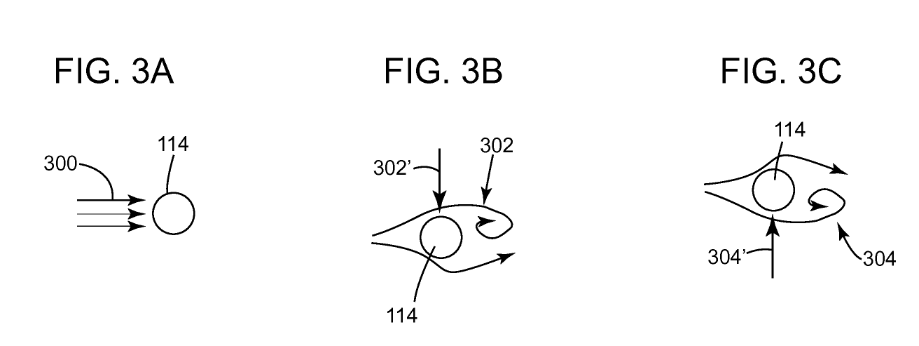

In addition to creating noise on traditional pressure sensors used in a seismic survey, transversal vibrations are especially visible for low frequencies in motion sensors used to record multicomponent seismic data. A reduction of such noise would therefore strongly improve the seismic data recorded by the motion sensors. FIGS. 3A-C shows a mechanism that creates the transversal noise. FIG. 3A shows a cross-section of lead-in 114 and water flow 300. When the water flow interacts with the lead-in 114 (note that FIG. 1 shows the lead-in making an angle with the inline direction, which means that the water flow, as the streamers are towed under water, interacts with the lead-in), a vortex 302 appears as illustrated in FIG. 3B. Alternatively, a vortex 304 may be formed as illustrated in FIG. 3C. Depending on the location (above or below the lead-in) of the vortex, it moves the lead-in upward or downward as illustrated by arrows 302′ and 304′, respectively. The vortex induces a vibration in the lead-in, the vortex induced vibration (VIV), which is transversal to the lead-in. VIV vibrations propagate along the lead-in, pass the VIMs, thus generating VIV noise in the streamers.

The inventors of this application have observed that if a stiffness of a portion of the lead-in is increased, the VIV noise that propagates along the lead-in can be reduced. Thus, various embodiments are now discussed and these embodiments achieve an increased stiffness in one or more portions of the lead-in. Note that the embodiments to be discussed next do not insert a new module between the lead-in and the streamer, as the VIM module, but they modify a portion of the lead-in to make it stiffer. Also note that bend limiting elements 136 and 138 are traditionally short elements, having a length of 10 m or less. These elements are not designed to reduce the transversal noise and also they are not long enough for significantly reducing the transversal noise.

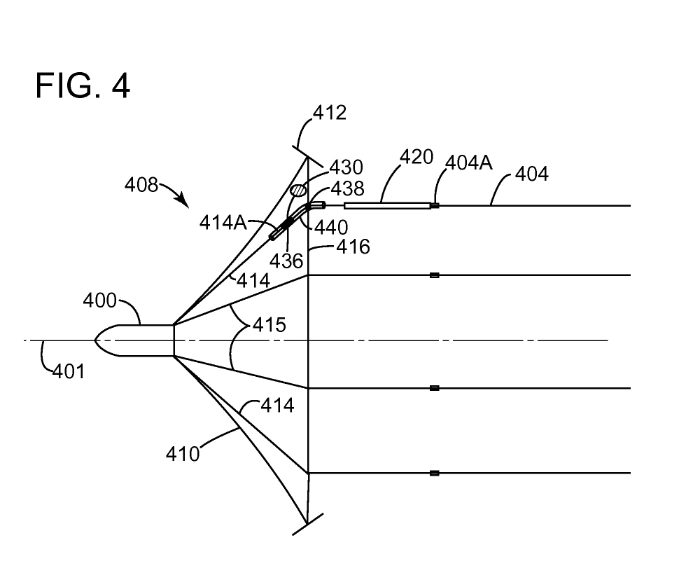

According to an embodiment illustrated in FIG. 4, at least a portion 414A of one lead-in 414 of front-end gear 408 is covered with a long bend limiting sleeve 440, which has an increased stiffness relative to the other parts of the lead-in. For example, in this embodiment, the lead-in 414 has a homogeneous (and uniform) stiffness along its entire length, from the vessel 400 to the VIM 420. However, for the portion 414A, because of the sleeve 440, an overall stiffness is increased. In one embodiment, sleeve 440 may partially extend over bend limiting element 436. In another embodiment, sleeve 440 may also extend over bend limiting element 438. Thus, in one embodiment, sleeve 440 covers both bend limiting elements 436 and 438.

Long bend limiting sleeve 440 has a length in the range of 10 to 100 m, and encircles portion 414A. In one embodiment, sleeve 440 has a length of about 50 m. In one application, the sleeve is 50 m or longer. In one embodiment, sleeve 440 completely encircles portion 414A. In another embodiment, sleeve 440 is made of a plastic material, metal, or other material that has a high stiffness. Long bend limiting sleeve 440 may be removed/attached to portion 414A as necessary. For example, when the lead-in is brought on the vessel, sleeve 440 is removed from the lead-in and only then the lead-in is stored on a spool.

In one embodiment, only the outer most lead-ins 414 are provided with the long bend limiting sleeve 440. In this respect, note that central lead-ins 415 are almost parallel to the inline direction 401, and thus, a transversal vibration is almost null. In another embodiment, a first group of lead-ins are receiving the long bend limiting sleeve while a second group of the lead-ins do not receive the sleeves. The first group includes the outer most lead-ins and one or more adjacent lead-ins while the second group includes the inner most lead-ins and one or more adjacent lead-ins. Note that a modern seismic acquisition system may include around 20 streamers, which means 20 lead-ins. This means that the first group may include the four most outer lead-ins while the second group may include the 16 more inner lead-ins. The ratio of the lead-ins in the first and second group can vary as desired by the seismic system's operator.

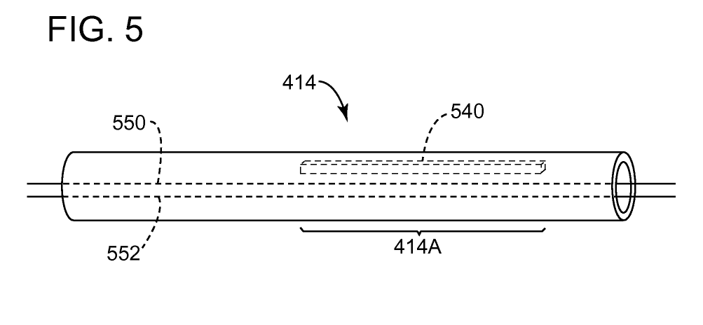

In another embodiment illustrated in FIG. 5, instead of placing a sleeve 440 outside and over a section 414A of lead-in 414, for increasing its stiffness, a solid member 540 is inserted within portion 414A to achieve the same effect. In other words, solid member 540 is completely embedded within lead-in 414. This can be achieved, for example, during a manufacturing process of the lead-in. Note that solid member 540 may be made of the same material and may have the same length as sleeve 440 discussed above. FIG. 5 shows lead-in 414 also including a strength member 550 (the lead-in has to pull long streamers through the water) and a data and communication member 552, for transmitting the seismic data to the vessel and for transmitting commands to the streamers.

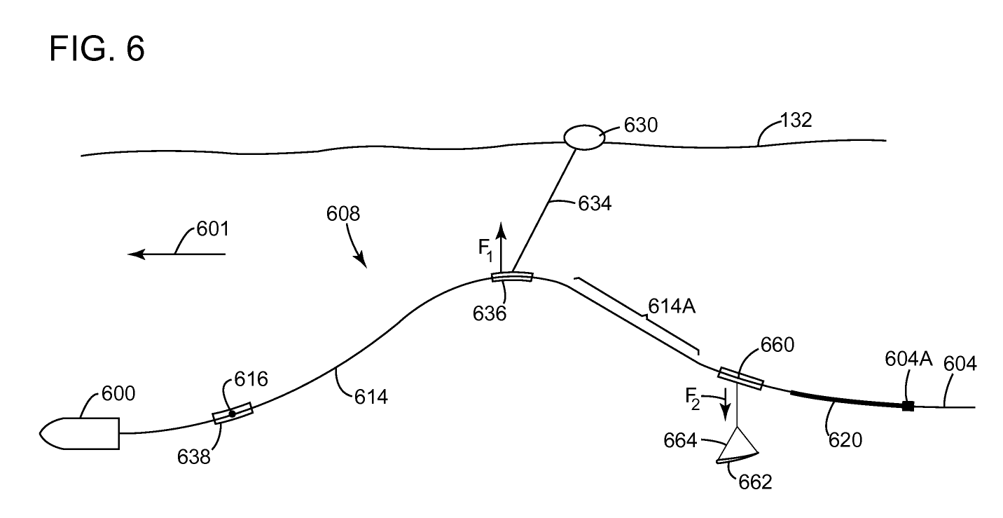

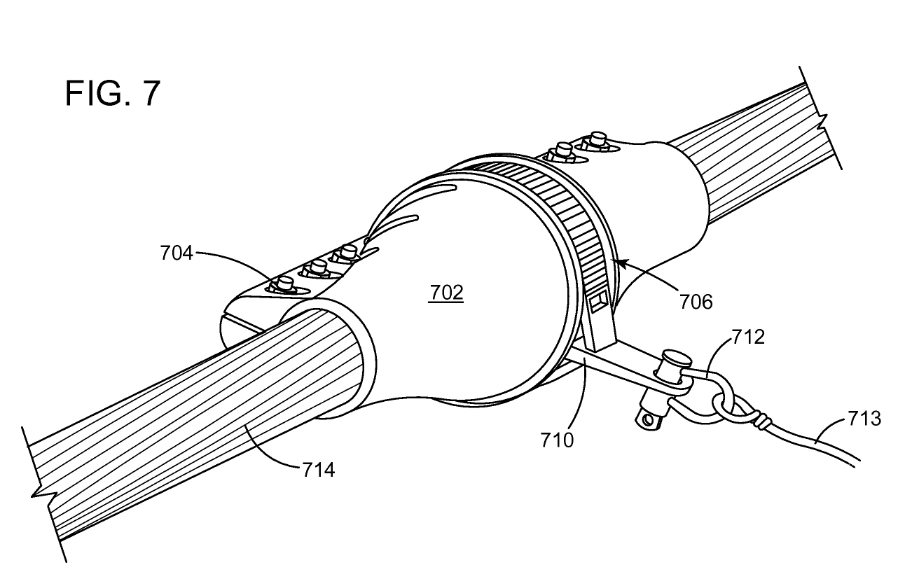

Those skilled in the art would understand that there are many other ways to increase the stiffness of at least a portion of the lead-in so that a transversal noise is attenuated. A further embodiment is now discussed with regard to FIG. 6, in which front-end gear 608 has a portion of the lead-in 614 stretched to prevent transversal oscillations to propagate from the vessel 600 to the streamers 604. The stretching is achieved by using the bend limiting element 636 and another bend limiting element 660 to define the stiff portion 614A. In one embodiment, the first bend limiting element 636 is closer to the sea surface 632 then the second bend limiting element 660. The bend limiting elements 636 and 660 may be made of the same material. In one embodiment, the bend limiting elements 636 and 660 have a length less than 2 m. As the lead-in 614 is towed by the vessel (not shown) along direction 601, float 630 and rope 634 exerted an upward force F1 on bend limiting element 636. A depressor (e.g., a wing) 662 attached with one or more ropes 664 to bend limiting element 660, is oriented such that a downward force F2 is applied on bend limiting element 660. Note that forces F1 and F2 are not at scale and not drawn to indicate their accurate orientation, but only to illustrate the effect of the float and depressor on portion 614A of lead-in 614. In one embodiment, forces F1 and F2 are substantially opposite to each other. In another embodiment, the magnitude of these forces is substantially the same. The term “substantially” is understood herein as describing a range of about 20%, due in part, to ocean currents, swells, etc. These two forces act to apply a tension in the portion of the lead-in spanning the distance L, to reduce transversal noise propagation toward the streamer.

The two forces F1 and F2 make the portion 614A to bend relative to the water surface 632, with a certain angle depending on the size of the depressor 662, and also make portion 614A tauter than the rest of the lead-in, which reduced the transversal vibrations (and noise) that can propagate along the lead-in. In one application, depressor 662 may be attached directly to bend limiting element 636, to prevent this portion of the lead-in to move transversally, thus, attenuating transversal noise. FIG. 6 also shows VIM 620 placed between streamer 604 and lead-in 614, and another bend limiting element 638 that connects to spread ropes 616. Bend limiting element 638 connects through the spread ropes 616 to corresponding bend limiting elements on other lead-ins in order to maintain a separation between the streamers constant. In one embodiment, region 614A has a length L that is equal to or longer than 5 m. In one application, the depressor may be placed upstream the float, along the lead-in. In one application, the two forces may be obtained by using floats, wings, weights, or any combination of these elements.

As previously discussed, although bend limiting elements 638, 636 and 660 may have a stiffness larger than that of the lead-in, their simply presence does not reduce the transversal vibrations to a satisfactory level because they are too short. For this reason, the embodiments of FIGS. 4 and 5 show a long sleeve (or element) that increases the stiffness of the lead-in over a large portion and the embodiment of FIG. 6 also shows a large portion 614A having an increased stiffness.

A typical bend limiting element 636 or 660 or 638 is illustrated in FIG. 7. These elements have a length of mostly 2 m. They include a housing 702 that fits over lead-in 714. Housing 702 is attached with bolts 704 to the lead-in. A central portion 706 accommodates a collar 710 or similar structure from which one or more ropes 713 are attached with a connecting mechanism 712 (e.g., clamp).

The above discussed embodiments advantageously provide at least one portion of a lead-in having a stiffer part than other portions of the lead-in for attenuating a transversal noise. While the above embodiments have disclosed the lead-in having one portion stiffer than the rest of the lead-in, it is also possible to have multiple portions of the lead-in being stiffer than other portions of the lead-in. For example, it is possible to have two distinct regions being stiffer than the remaining lead-in, with one region being stiffer than the second region.

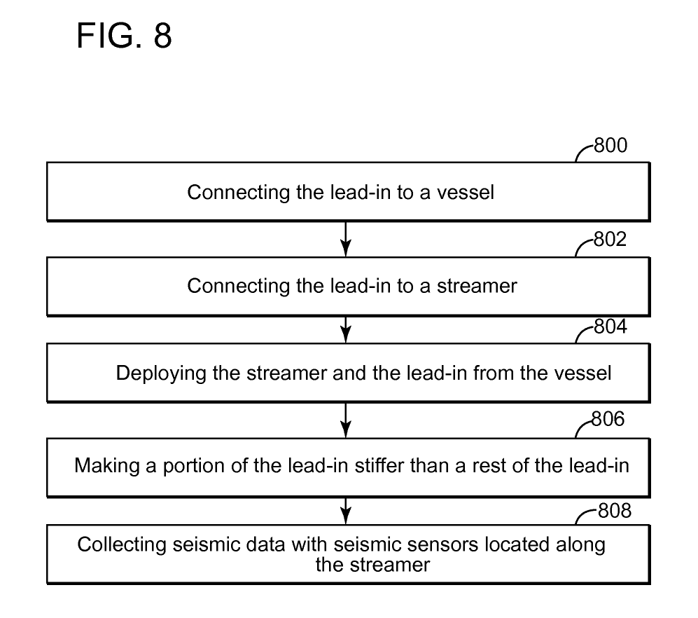

According to an embodiment, there is a method for reducing transversal movement in a lead-in. The method, which is illustrated in FIG. 8, includes a step 800 of connecting the lead-in to a vessel, a step 802 of connecting the lead-in to a streamer, a step 804 of deploying the streamer and the lead-in from the vessel, a step 806 of making a portion of the lead-in stiffer than a rest of the lead-in, and a step 808 of collecting seismic data with seismic sensors located along the streamer. The portion of the lead-in that is stiffer than the rest reduced a transversal noise that propagates from the lead-in to the streamer.

In one application, the step of making includes adding a stiff material to the lead-in, as discussed above with regard to FIG. 4 or 5. In another application, the step of making includes adding a depressor to the lead-in so that the portion is sandwiched between the depressor and a bend limiting element that is connected to a float, as illustrated in FIG. 6.

The disclosed exemplary embodiments provide a lead-in, front-end gear and method for attenuating transversal noise that propagates from the lead-in to a corresponding streamer. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A front-end gear that connects a streamer to a vessel, the front-end gear comprising:
a lead in that connects to the streamer;
a first bend limiting element attached to the lead-in and to a float that floats at a sea surface;
a second bend limiting element attached to the lead-in, a distance L away from the first bend limiting element; and
a depressor attached to the second bend limiting element,
wherein the float generates a first force (F1) on the lead-in and the depressor generates a second force (F2) on the lead-in when the lead-in is towed underwater, and
wherein the first and second forces act to apply a tension in a portion of the lead-in spanning the distance L, to reduce transversal noise propagation toward the streamer.

2. The front-end gear of claim 1, wherein the first and second forces have substantially opposite directions.

3. The front-end gear of claim 1, wherein the depressor is configured to move away from the sea surface when towed.

4. The front-end gear of claim 1, wherein the first bend limiting element is located closer to the sea surface then the second bend limiting element.

5. The front-end gear of claim 1, further comprising:
a vibration insulation module located between the lead-in and the streamer to reduce axial vibrations.

6. The front-end gear of claim 5, wherein the lead-in is directly connected to the vessel and the vibration insulation module.

7. The front-end gear of claim 1, wherein the distance L is about 5 m.

8. The front-end gear of claim 1, wherein the distance L is 5 m or more.

9. The front-end gear of claim 1, wherein the second bend limiting element is located between the first bend limiting element and the streamer along the lead-in.

10. The front-end gear of claim 1, wherein the first bend limiting element is located between the second bend limiting element and the streamer along the lead-in.

11. The front-end gear of claim 1, further comprising:
a third bend limiting element attached to the lead-in, and configured to connect to corresponding bend limiting elements on other lead-ins with separation ropes for maintaining a separation between streamers constant.

12. A front-end gear that connects a streamer to a vessel, the front-end gear comprising:
a lead in having a stiffer portion, which is stiffer than a rest of the lead-in; and
a stiff material located in the stiff portion for making the stiffer portion stiffer than the rest of the lead-in.

13. The front-end gear of claim 12, wherein the stiff material is located inside the lead-in.

14. The front-end gear of claim 12, wherein the stiff material is a sleeve that is removably attached on an outside of the lead-in.

15. The front-end gear of claim 12, wherein the stiff material is 50 m or longer along the lead-in.

16. The front-end gear of claim 12, further comprising:
a first bend limiting element attached to the lead-in and to a float that floats at a sea surface; and
a second bend limiting element attached to the lead-in and to a corresponding separation rope,
wherein the stiff material is a sleeve that extends over the first and second bend limiting elements.

17. The front-end gear of claim 12, further comprising:
a vibration insulation module located between the lead-in and the streamer to reduce axial vibrations.

18. A method for reducing transversal movement in a lead-in, the method comprising:
connecting the lead-in to a vessel;
connecting the lead-in to a streamer;
deploying the streamer and the lead-in from the vessel;
making a portion of the lead-in stiffer than a rest of the lead-in; and
collecting seismic data with seismic sensors located along the streamer,
wherein the portion of the lead-in that is stiffer than the rest reduces a transversal noise that propagates from the lead-in to the streamer.

19. The method of claim 18, wherein the step of making comprises:
adding a stiff material to the lead-in.

20. The method of claim 18, wherein the step of making comprises:
adding a depressor to the lead-in so that the portion is sandwiched between the depressor and a bend limiting element that is connected to a float.
